(19) United States
(12) Patent Application Publication
(10) Pub. No.: US 2024/0300408 A1
(43) Pub. Date: Sep. 12, 2024

(54) SELECTIVELY DEPLOYABLE HANDICAP ALERT SYSTEM FOR A VEHICLE

(71) Applicant: GM Global Technology Operations LLC, Detroit, MI (US)

(72) Inventors: Zachary Michael Masse, Farmington Hills, MI (US); Kenneth V. Hollewa, Washington Twp, MI (US)

(21) Appl. No.: 18/180,322

(22) Filed: Mar. 8, 2023

(51) Int. Cl. B60Q 1/50; B60Q 1/48

(52) U.S. Cl. CPC B60Q 1/544; B60Q 1/48; B60Q 1/503

(57) ABSTRACT

A selectively deployable handicap alert for a vehicle, includes a first member fixedly connectable to the vehicle and a second member pivotally connected to the first member. The second member includes a third member. A deployment system is operatively connected to the second member. The deployment system is operable to extend the second member outwardly of the vehicle and deploy the third member downwardly. The third member blocks access to a space adjacent to the vehicle.

### INTRODUCTION

The subject disclosure relates to the art of vehicles and, more particularly, to a selectively deployable handicap alert system for a vehicle.

Most if not all public and private parking facilities include spaces designed to accommodate handicapped drivers/passengers. The spaces designated for handicap use are typically located near an entrance or exit from the facility, are larger than other spaces, and are specially marked for handicap use. Often times, a buffer is provided directly adjacent to handicap spaces. The buffer provides additional space that aids a user in entering and exiting their vehicle. Drivers and/or passengers that are confined to a wheel chair or similar assistive device find the buffer particularly useful.

Occasionally, non-handicap drivers will, for one reason or another, position their vehicle in the buffer. Encroachment into the buffer may occur before or after a handicap driver parks in a designated handicap space. If the encroachment occurs before the handicapped driver parks in the designated space, and if the buffer is needed, the handicapped driver may choose to park in a different space. If however, encroachment into the buffer occurs after the handicapped driver parks, re-entry into the vehicle driven by a person in a wheel chair may be impaired.

If, upon returning to the vehicle, access to the vehicle is limited, the handicapped driver may be required to wait, sometimes hours, for the return of the driver of the encroaching vehicle or for a tow vehicle to remove the encroaching vehicle before being able to resume his/her journey. Accordingly, it is desirable to provide a system for a handicapped driver to alert other drivers to the use of the buffer.

### SUMMARY

A selectively deployable handicap alert for a vehicle, in accordance with a non-limiting example, includes a first member fixedly connectable to the vehicle and a second member pivotally connected to the first member. The second member includes a third member. A deployment system is operatively connected to the second member. The deployment system is operable to extend the second member outwardly of the vehicle and deploy the third member downwardly. The third member blocks access to a space adjacent to the vehicle.

In addition to one or more of the features described herein the deployment system includes a motor operatively connected to the second member, the motor being operable to rotate the second member between a deployed configuration in which the second member extends outwardly of the vehicle and a stowed configuration in which that second member does not extend outwardly of the vehicle.

In addition to one or more of the features described herein the second member includes a housing selectively containing the third member.

In addition to one or more of the features described herein a spool is arranged in the housing, the third member being disposed about the spool.

In addition to one or more of the features described herein a motor member is operatively connected to the spool, the motor member being operable to selectively deploy and retract the third member.

In addition to one or more of the features described herein a position sensor connected to the second member, the motor being operable to selectively deploy the third member based on a position of the second member as sensed by the position sensor.

In addition to one or more of the features described herein an alert system is operable to issue a warning if the second member does not fully deploy based on the position of the second member as sensed by the position sensor.

In addition to one or more of the features described herein the deployment system is operatively connected to the vehicle, the deployment system being operable to deploy the second member based on one or more vehicle conditions.

In addition to one or more of the features described herein the one or more vehicle conditions include at least one of an engine operating state, a transmission operating state, and a parking brake operating state.

In addition to one or more of the features described herein a lock member is operable to selectively secure the second member relative to the first member.

A vehicle, in accordance with a non-limiting example, includes a body and a door pivotally mounted to the body. The door being selectively pivotable between a closed position and an extended position. A selectively deployable handicap alert is mounted to the body. The selectively deployable handicap alert includes a first member fixedly connected relative to the body and a second member pivotally connected to the first member. The second member includes a third member. A deployment system is operatively connected to the second member. The deployment system is operable to extend the second member outwardly of the vehicle and deploy the third member downwardly. The third member blocks access to a space adjacent to the vehicle.

In addition to one or more of the features described herein a motor is operatively connected to the second member, the motor being operable to rotate the second member between a deployed configuration in which the second member extends outwardly of the vehicle and a stowed configuration in which that second member does not extend outwardly of the vehicle.

In addition to one or more of the features described herein the second member includes a housing selectively containing the third member.

In addition to one or more of the features described herein a spool is arranged in the housing, the third member being disposed about the spool.

In addition to one or more of the features described herein a motor member is operatively connected to the spool, the motor member being operable to selectively deploy and retract the third member.

In addition to one or more of the features described herein a position sensor is connected to the second member, the motor being operable to selectively deploy the third member based on a position of the second member as sensed by the position sensor.

In addition to one or more of the features described herein an alert system is operable to issue a warning if the second member does not fully deploy based on the position of the second member as sensed by the position sensor.

In addition to one or more of the features described herein the deployment system is operatively connected to the vehicle, the deployment system being operable to deploy the second member based on one or more vehicle conditions.

In addition to one or more of the features described herein the one or more vehicle conditions include at least one of an engine operating state, a transmission operating state, and a parking brake operating state.

A method of blocking a space adjacent to a vehicle including a handicap alert system, in accordance with a non-limiting example, includes activating handicap alert system mounted to the vehicle, deploying a member outwardly of the vehicle into a handicap access zone provided adjacent the vehicle, and deploying another member downwardly from the member, the another member including a visual alert indicating that the handicap access zone is in use.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left rear perspective view of a vehicle including a selectively deployable handicap alert in a deployed state, in accordance with a non-limiting example;

FIG. 2 is a is a left rear perspective view of the vehicle of FIG. 1 with the selectively deployable handicap alert in a stowed state, in accordance with a non-limiting example;

FIG. 3 depicts the selectively deployable handicap alert deployed from a roof rack of the vehicle of FIG. 1, in accordance with a non-limiting example;

FIG. 4 depicts the selectively deployable handicap alert stowed on the roof rack of the vehicle of FIG. 1, in accordance with a non-limiting example;

FIG. 5 is a flow chart depicting a method of deploying the selectively deployable alert, in accordance with a non-limiting example; and

FIG. 6 is a flow chart depicting a method of stowing the selectively deployable alert, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

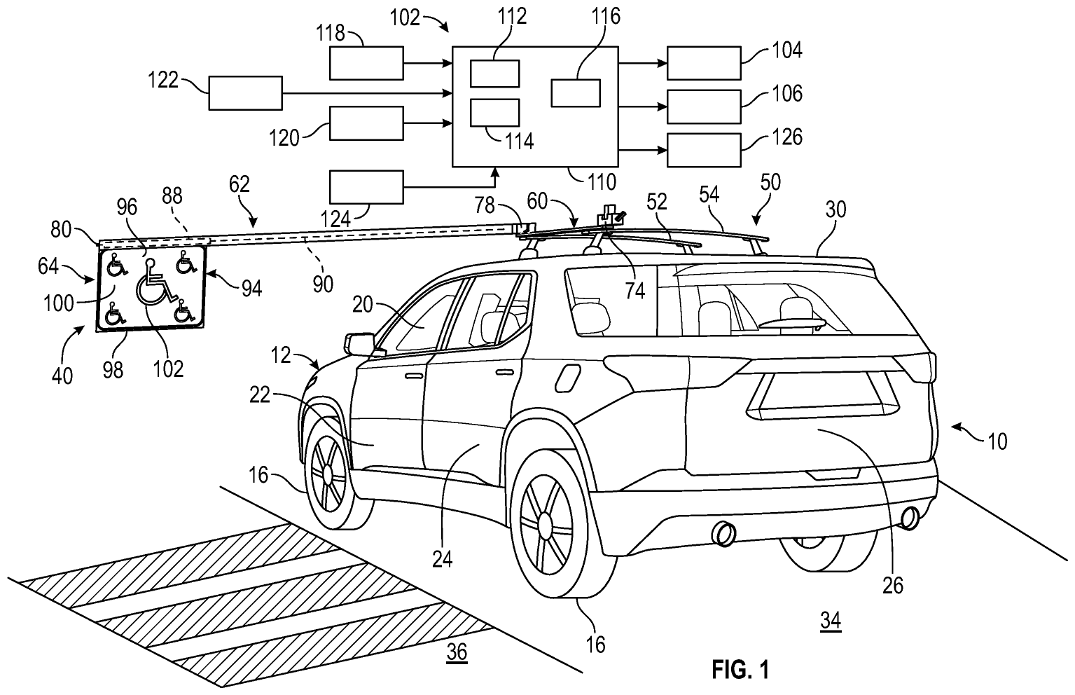

A vehicle, in accordance with a non-limiting example, is indicated generally at 10 in FIG. 1. Vehicle 10 is shown in the form of a sport utility vehicle (SUV). It should however be understood that vehicle 10 is not limited to the particular body type shown and could take on various other forms including passenger vehicles, pickup trucks, vans, and the like. Vehicle 10 includes a body 12 supported on a plurality of wheels, two of which are indicated at 16. Body 12 defines a passenger compartment 20 that may be accessed through a front door 22 or a rear door 24. A rear cargo area (not separately labeled) may be accessed via a hatch 26. Vehicle 10 is also shown to include a roof 30.

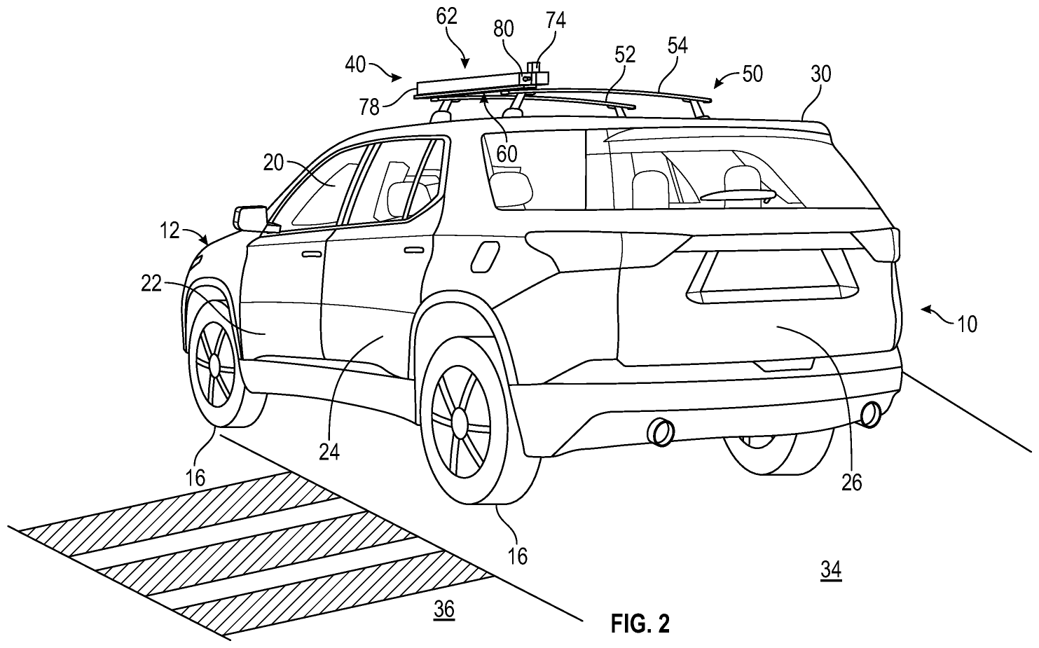

In the non-limiting example shown in FIGS. 1 and 2, vehicle 10 is parked in a handicap parking space 34 having a handicap access zone 36. Handicap access zone 36 provides an area that supports access by a wheelchair or other assistive device (not shown) employed by a passenger or driver of vehicle 10. In a non-limiting example, vehicle 10 supports a selectively deployable handicap alert system 40. Selectively deployable handicap alert system 40 may transition between a stowed configuration (FIG. 2) with vehicle 10 ready to travel, and a deployed configuration (FIG. 1) displaying an alert that signals others that access zone 36 is in use.

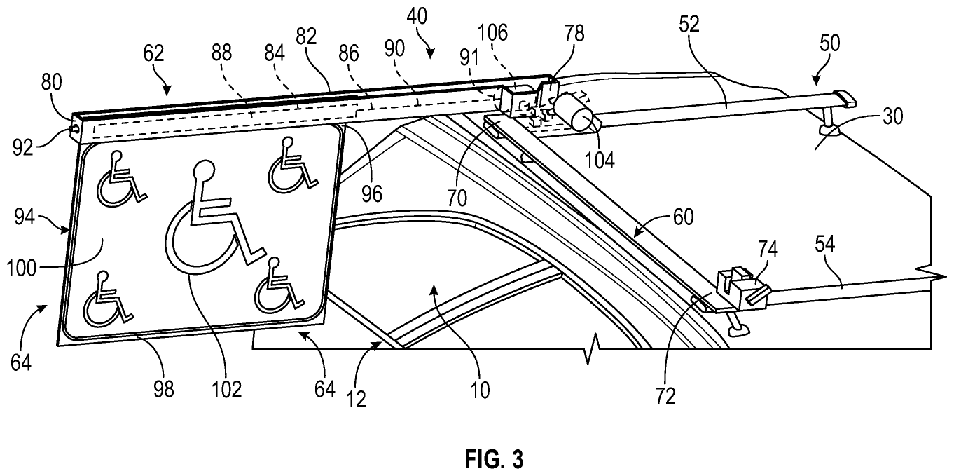

In a non-limiting example, vehicle 10 includes a rack 50 mounted to roof 30. As shown in FIG. 3, rack 50 includes a first support rail 52 and a second support rail 54. Selectively deployable handicap alert system 40 is shown mounted to rack 50 between first support rail 52 and second support rail 54 in accordance with one non-limiting example. Of course, it should be understood that selectively deployable handicap alert system 40 may be mounted to other vehicle surfaces including fenders, bumpers, hitch receivers and the like.

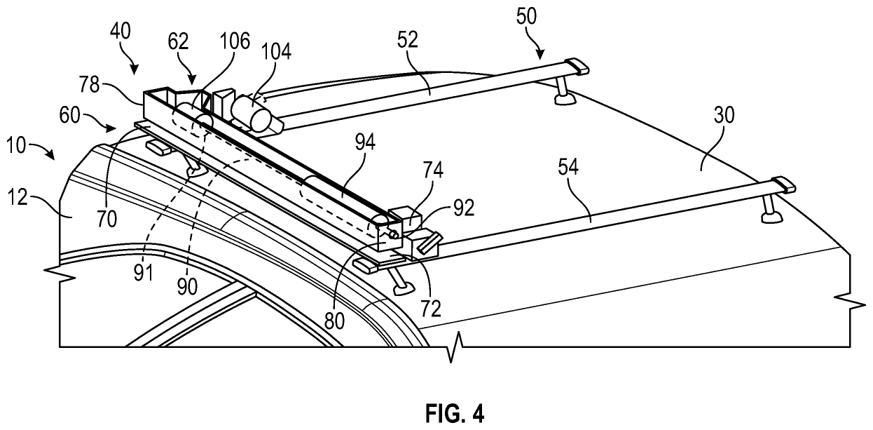

In a non-limiting example illustrated in FIGS. 3 and 4, selectively deployable handicap alert system 40 includes a first member 60 fixedly connected between first support rail 52 and second support rail 54, a second member 62 pivotally connected to first member 60, and a third member 64 which, as will be detailed herein, supports an alert message. First member 60 includes a first end 70 fixedly connected to first support rail 52 and a second end 72 fixedly connected to second support rail 54. Second end 72 supports a lock member 74 that constrains movement of second member 62 when vehicle 10 is in, or is preparing to be, in motion.

Second member 62 includes a first end portion 78, a second end portion 80, and an intermediate portion 82. Intermediate portion 82 extends between first end portion 78 and second end portion 80. Second member 62 includes a hollow interior 84 that forms a housing 86 that is receptive of third member 64. In a non-limiting example, a spool 88 is arranged in housing 86. Spool 88 is mounted to, and/or connected with, an axle 90. Axle 90 includes a first end section 91 arranged at first end portion 78 of second member 62 and a second end section 92 that extends outwardly of second end portion 80.

Third member 64, in a non-limiting example, takes the form of a banner 94 that may be selectively wound onto and off from spool 88. That is, third member 64 includes a first end section 96 connected to spool 88 and a second end section 98 that may simply hang from second member 62. Banner 92 includes a surface 100 that presents an alert message in the form of a graphic 102. Of course the particular nature of the alert message may vary and could include text, or text and graphics. The alert notifies others that may wish to park adjacent to handicap parking space 34 that handicap access zone 36 is in use. In a non-limiting example, banner 96, when deployed, may block access to handicap access zone 36.

In a non-limiting example illustrated in FIG. 1, selectively deployable handicap alert system 40 includes a deployment system 102 that shifts second member 62 outwardly of vehicle 10, and unspools third member 64 downwardly. Deployment system 102 includes a first motor 104 connected to second member 62 at first end portion 78 and a second motor 106 that is connected to axle 90 at first end section 91. In a non-limiting example, deployment system 102 includes a controller 110 that is operatively connected to first motor 104 and second motor 106. Controller 110 includes a central processing unit (CPU) 112, a non-volatile memory 114, and a control module 116.

Controller 110 is further connected to a vehicle interface 118 that provides vehicle status information (e.g., transmission position, motor operation, brake position) to control module 116. Controller 110 is also coupled to a motor sensor 120 that detects operational states of first motor 104 and an area sensor 122 that detects the presence of obstacles in handicap access zone 36. Further, controller 110 is connected to an actuator 124 that enables a user to deploy selectively deployable handicap alert system 40 as shown in FIGS. 1 and 3 and/or stow selectively deployable handicap alert system 40 as shown in FIGS. 2 and 4. Controller 110 may also provide alerts to a user through a vehicle display 126 regarding deployment and storage status of selectively deployable handicap alert system 40 as will be detailed herein.

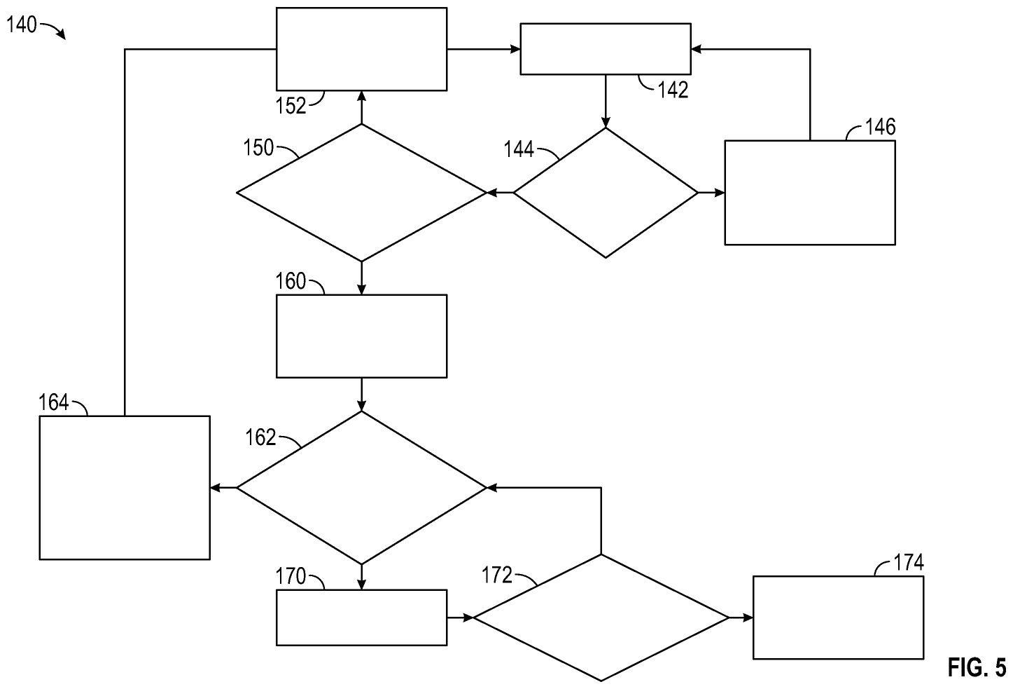

Reference will now follow to FIG. 5 in describing a method 140 of deploying selectively deployable handicap alert system 40. After parking in handicap parking space 34, a user may activate actuator 124 to deploy banner 92 across handicap access zone 36 as indicated in block 142. At this point, control module 116 determines, by accessing vehicle interface 118, whether vehicle 10 is in park in block 144. If vehicle 10 is not in park, a message is displayed to the user in block 146 requesting that the transmission be placed in park. Once it is determined that the transmission is in park, control module 116 senses for the presence of obstacles in a deployment path in block 150. If obstacles are present, a message is displayed on vehicle display 126 in block 152 indicating that the obstacles need to be moved.

Once handicap access zone 36 is free of obstacles, control module 116 operates first motor 104 to release locking member 74 and begin to deploy second member 62 in block 160. As second member 62 deploys, control module 116, through motor sensor 120 detects motor torque. If motor torque increases, a determination is made in block 162 that something may be blocking deployment of second member 62 and a warning is issued to the user in block 164. If torque remains substantially constant, second member 62 continues to deploy in block 170 and a determination is made whether second member 62 is fully deployed in block 172. If second member 62 is not fully deployed, method 140 returns to block 162. Once second member 62 is fully deployed, second motor 106 is activated to unfurl third member 64 in block 174 displaying alert message to the public. At this point, the user may exit vehicle 10 using handicap access zone 36.

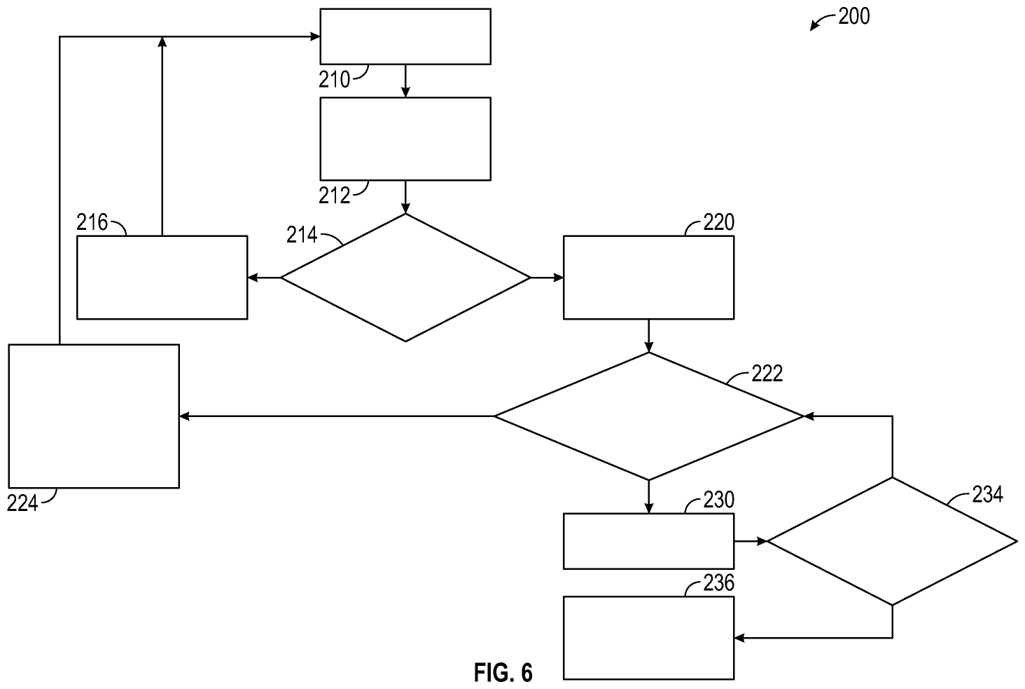

Once the user returns to vehicle 10, handicap access zone 36 should be available to use to enter passenger compartment 20. Once in passenger compartment 20, selectively deployable handicap alert system 40 may be stowed. A method of stowing selectively deployable handicap alert system 40 is indicated at 200 in FIG. 6. To stow selectively deployable handicap alert system 40, the user activates actuator 124 in block 210. At this point, control module, 116 activates second motor 106 to roll up banner 92 onto spool 88 in block 212. Control module 116 senses for obstacles in a stowing path of second member 62 in block 214. If an obstacle is present, an alert is displayed on vehicle display 126 in block 216. If no obstacles are detected, control module 116 activates first motor 104 to begin rotating second member 62 inwardly toward vehicle 10 in block 220.

As second member 62 is pivoting inwardly, control module 116, through motor sensor 120, detects motor torque. If motor torque increases, a determination is made in block 222 that something may be blocking movement of second member 62 and a warning is issued to the user in block 224. If torque remains substantially constant, control module 116 continues to operate first motor 104 in block 230 to pivot second member 62 inwardly. In block 234, a determination is made whether second member 62 is fully stowed. Also in block 234 lock member 74 may be activated to secure second member 62 to first member 60. Once second member 62 is locked in place a message is issued in block 236 that selectively deployable handicap alert system 40 is stowed.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A selectively deployable handicap alert for a vehicle comprising:
a first member fixedly connectable to the vehicle;
a second member pivotally connected to the first member, the second member including a third member; and
a deployment system operatively connected to the second member, the deployment system being operable to extend the second member outwardly of the vehicle and deploy the third member downwardly, the third member blocking access to a space adjacent to the vehicle.

2. The selectively deployable handicap alert according to claim 1, wherein the deployment system includes a motor operatively connected to the second member, the motor being operable to rotate the second member between a deployed configuration in which the second member extends outwardly of the vehicle and a stowed configuration in which that second member does not extend outwardly of the vehicle.

3. The selectively deployable handicap alert according to claim 2, wherein the second member includes a housing selectively containing the third member.

4. The selectively deployable handicap alert according to claim 3, further comprising a spool arranged in the housing, the third member being disposed about the spool.

5. The selectively deployable handicap alert according to claim 4, further comprising a motor member operatively connected to the spool, the motor member being operable to selectively deploy and retract the third member.

6. The selectively deployable handicap alert according to claim 5, further comprising a position sensor connected to the second member, the motor being operable to selectively deploy the third member based on a position of the second member as sensed by the position sensor.

7. The selectively deployable handicap alert according to claim 6, further comprising an alert system operable to issue a warning if the second member does not fully deploy based on the position of the second member as sensed by the position sensor.

8. The selectively deployable handicap alert according to claim 1, wherein the deployment system is operatively connected to the vehicle, the deployment system being operable to deploy the second member based on one or more vehicle conditions.

9. The selectively deployable handicap alert according to claim 8, wherein the one or more vehicle conditions include at least one of an engine operating state, a transmission operating state, and a parking brake operating state.

10. The selectively deployable handicap alert according to claim 1, further comprising a lock member operable to selectively secure the second member relative to the first member.

11. A vehicle comprising:
a body;
a door pivotally mounted to the body, the door being selectively pivotable between a closed position and an extended position; and
a selectively deployable handicap alert mounted to the body, the selectively deployable handicap alert comprising:
a first member fixedly connected relative to the body;
a second member pivotally connected to the first member, the second member including a third member; and
a deployment system operatively connected to the second member, the deployment system being operable to extend the second member outwardly of the vehicle and deploy the third member downwardly, the third member blocking access to a space adjacent to the vehicle.

12. The vehicle according to claim 11, wherein the deployment system includes a motor operatively connected to the second member, the motor being operable to rotate the second member between a deployed configuration in which the second member extends outwardly of the vehicle and a stowed configuration in which that second member does not extend outwardly of the vehicle.

13. The vehicle according to claim 12, wherein the second member includes a housing selectively containing the third member.

14. The vehicle according to claim 13, further comprising a spool arranged in the housing, the third member being disposed about the spool.

15. The vehicle according to claim 14, further comprising a motor member operatively connected to the spool, the motor member being operable to selectively deploy and retract the third member.

16. The vehicle according to claim 15, further comprising a position sensor connected to the second member, the motor being operable to selectively deploy the third member based on a position of the second member as sensed by the position sensor.

17. The vehicle according to claim 16, further comprising an alert system operable to issue a warning if the second member does not fully deploy based on the position of the second member as sensed by the position sensor.

18. The vehicle according to claim 11, wherein the deployment system is operatively connected to the vehicle, the deployment system being operable to deploy the second member based on one or more vehicle conditions.

19. The vehicle according to claim 18, wherein the one or more vehicle conditions include at least one of an engine operating state, a transmission operating state, and a parking brake operating state.

20. A method of blocking a space adjacent to a vehicle including a handicap alert system, the method comprising:
activating handicap alert system mounted to the vehicle;
deploying a member outwardly of the vehicle into a handicap access zone provided adjacent the vehicle; and
deploying another member downwardly from the member, the another member including a visual alert indicating that the handicap access zone is in use.
